(19) United States
(12) Patent Application Publication
(10) Pub. No.: US 2017/0267060 A1
(43) Pub. Date: Sep. 21, 2017

(54) COOLING SYSTEM FOR A MOTORCYCLE

(71) Applicant: Anthony E. Majoros, Cypress, CA (US)

(72) Inventor: Anthony E. Majoros, Cypress, CA (US)

(21) Appl. No.: 15/458,857

(22) Filed: Mar. 14, 2017

Related U.S. Application Data
(60) Provisional application No. 62/308,712, filed on Mar. 15, 2016.

(51) Int. Cl. B60H 1/00; B60H 1/24; B62J 99/00

(52) U.S. Cl. CPC B60H 1/00407; B62J 99/00; B60H 1/00764; B60H 1/00771; B60H 1/00828; B60H 1/242; B60H 1/00964

(57) ABSTRACT

A motorcycle cooling system that includes a controller, a sensing member for sensing at least one environmental condition and that is in communication with the controller, and a fan assembly. The fan assembly includes a shroud having an inner surface that defines a central opening extending therethrough, and a fan in airflow communication with the central opening. The fan is configured to move air through the central opening from a first end to a second end of the shroud. The fan is in communication with the controller. The controller turns the fan on when a first environmental condition is sensed by the sensing member and the controller turns the fan off when a second environmental condition is sensed by the sensing member.

### CROSS REFERENCE TO RELATED APPLICATIONS

This application claims the benefit of U.S. Provisional Application No. 62/308,712, filed Mar. 15, 2016, which is herein incorporated by reference in its entirety.

### FIELD OF THE INVENTION

The present invention relates generally to a cooling system that includes a fan mounted on a motorcycle.

### BACKGROUND OF THE INVENTION

Motorcycle riders may endure extreme discomfort due to heat when they ride in urban areas where a significant amount of riding time is spent with little airflow (i.e., the motorcycle is either stopped or moving slowly), they ride during times of high ambient temperatures with average or above average humidity, and they ride in times of average or above average solar irradiation (e.g., summer months in North America). Most riders wear no specialized apparel for cooling in hot weather, so they can experience stifling heat when they come to repeated stops in dense traffic. A properly designed fan can partly address the problem. Existing and prior attempts using fans to address the problem have not been successful.

Existing fans for motorcycles and bicycles often produce an airflow that does not reach the rider's face. Slight air currents around the stopped motorcycle, and rising air from the motorcycle engine are enough to disturb the airflow from existing fans and prevent any fan-produced airstream from cooling the rider's face. Many existing fans are desk-type designs with open, not ducted or shrouded, fan blades; additionally, they do not have a style or appearance that is acceptable to the motorcycle community. Many existing fans have no particular feature that can reduce the effect of the inlet side pulling in hot air that rises from the engine area (when the motorcycle is stopped). If a fan draws in hot air, it then expels this hot air toward the rider's face; this effect that can be more uncomfortable than not having a fan.

Many existing fans do not have a method of control other than on and off. In the usual situation, the rider can turn a fan on after he/she comes to a stop, although doing this repeatedly in stop-and-go traffic becomes tedious and frustrating. More importantly, when the rider accelerates away from a stop (and the fan is running), it is inconvenient and distracting to manually turn the fan off just before moving; and it is inconvenient, distracting, and possibly unsafe to turn the fan off during or after accelerating in traffic. Generally, a rider will not want to run a fan while the bike is moving.

### SUMMARY OF THE PREFERRED EMBODIMENTS

In accordance with a first aspect of the present invention there is provided a motorcycle cooling system that includes a controller, a sensing member for sensing at least one environmental condition and that is in communication with the controller, and a fan assembly. The fan assembly includes a shroud having an inner surface that defines a central opening extending therethrough, and a fan in airflow communication with the central opening. The fan is configured to move air through the central opening from a first end to a second end of the shroud. The fan is in communication with the controller. The controller turns the fan on when a first environmental condition is sensed by the sensing member and the controller turns the fan off when a second environmental condition is sensed by the sensing member.

In a preferred embodiment, the sensing member is at least one of an airflow sensor, an airflow switch, an accelerometer, a global positioning system receiver, a photocell, a wheel speed sensor, a camera or a motion switch. Preferably, the environmental condition is at least one of wind speed, temperature or vehicle speed. In a preferred embodiment, the system further includes a switch assembly that includes a mode switch that is movable between a manual position and an automatic position. When the mode switch is in the manual position the controller does not control the fan.

In a preferred embodiment, the switch assembly further includes a power switch for turning the system on and off. Preferably, the central opening includes a duct member positioned therein that includes an inner surface and an outer surface. An inner duct pathway is defined by the inner surface and an outer duct pathway is defined between the outer surface of the duct member and the inner surface of the shroud. Preferably, at least one vane extends inwardly from the inner surface of the shroud to position the duct member coaxially within the central opening. In a preferred embodiment, the duct member has a first end and a second end and the length of the duct member from the first end to the second end is shorter than the length from the first end to the second end of the shroud.

In a preferred embodiment, the central opening includes a tapered portion and a non-tapered portion adjacent the second end of the shroud. Preferably, the fan assembly includes an adjustment member comprised of at least first and second connection members that each include a generally spherical male portion and a generally spherical female portion. The male portion of the first connection member is received in the female portion of the second connection member. Preferably, the male portion of the second connection member is adjustably received in a neck portion of the shroud.

In a preferred embodiment, the fan assembly is mounted on a handlebar of a motorcycle, and the sensing member is mounted on the motorcycle at a position remote from the fan assembly. Preferably, when the mode switch is in the automatic position the controller controls the fan. Preferably, the sensing member senses relative airflow speed, and, the fan is turned on when the relative airflow speed is above a predetermined threshold.

The inventive cooling system and fan assembly is designed to provide a stream of ambient air to the rider's face, assuming that he/she is using an open-face helmet or can lift the visor of a full face helmet. Some cooling sensation is achieved when the air stream evaporates perspiration off the rider's face. Additionally, some psychological benefit is provided by having the option of turning the fan on, an effect called adaptive thermal comfort. A fan may be the only source of relief from extreme heat if the rider does not wear any specialized cooling gear. Also, when the motorcycle is stopped the fan helps to keep the rider's goggles free of condensation by forcing air behind the goggle lenses, and if directed downward can disperse hot air rising from the engine.

In a preferred embodiment, the fan assembly (the fan casing or shroud plus the fan and motor) is a ducted, vane axial type. Preferably, it is designed to be small and to produce a laminar airflow that will propel a stream of air a predetermined distance (e.g., at least 30 inches) beyond the front edge of the front end of the shroud. A laminar airflow helps to overcome the effects of minor air currents and rising air from the engine that would normally disrupt a directed stream of air. In a preferred embodiment, the fan assembly produces airflow of about 30 cubic feet per minute. The airstream preferably is concentrated enough at about 30 inches to provide some relief to the rider's face. However, other airflows and distances are within the scope of the present invention.

In a preferred embodiment, the fan casing or shroud includes an arrangement of convergent nozzle, vanes, inner and outer duct, and weight reducing cavities. It also preferably includes a particular mounting style. The design is functional for laminar airflow and it has a style that is suitable for the motorcycle community. The duct and finger guard may be plastic, metal, fiberglass, carbon fiber, or other appropriate material. The finish may be any color, or chrome, or be non-reflective.

In an exemplary embodiment, the fan operates on 12 volts DC and draws approximately 2 amps. It can be powered by the motorcycle electrical system or it may be powered by a battery or separate electrical system. The fan assembly and cooling system can also be adapted to wheelchair use. In a preferred embodiment, the fan shroud is connected to a flexible arm or adjustment member mounted to the motorcycle handlebar. The arm enables adjustment so the airflow can be directed to the rider's face. The adjustment member can be a modular ball and socket type or gooseneck or other type of adjustment member that allows the positioning and direction of the fan to be adjusted. In a preferred embodiment, the flexible arm is hollow so that wires can be routed through the arm to the handlebar mounting member or assembly. If the mount is fitted with a mechanism to grip and release the arm (and the arm and mount are fitted with an electrical plug and jack), the fan assembly (with its arm) may be disconnected from the mount. The mount may accommodate switches and assemblies such as integrated circuits to control the fan. The flexible arm or adjustment member also permits the fan to be positioned so that the effects of drawing in hot air rising from the motorcycle engine are minimized. It will be appreciated by those of ordinary skill in the art that the fan does not require the rider to don any special gear or apparel. On/off control of the fan can be manual with a toggle switch. In another embodiment, the control may be automatic with at least the following methods. The system can be controlled by an airflow sensor. In an exemplary embodiment, a sensing member with an airflow or other environmental condition sensor (e.g., temperature humidity, solar radiation or a combination thereof with airspeed) is located on the motorcycle such that it can sense changes in air movement or other conditions. It will be appreciated that air movement at the location of the sensor has some positive correlation with air movement near the rider's face. The logic associated with the sensor examines trends in air movement and can be adjusted to a level of sensitivity selected by the rider. When a trend of no or very small air movement is detected, a latching relay closes and routes power to the fan. When a trend of substantial air movement is detected, the latching relay opens and stops power to the fan.

The system can be controlled by an airflow switch. In this embodiment, a normally closed airflow switch is positioned on the motorcycle such that when the motorcycle is stopped, the lack of air movement over the switch causes the switch contacts to close, which closes a relay to route power to the fan. When the motorcycle is in motion, the resulting air movement over the switch assembly causes the switch contacts to open, which opens a relay and stops power to the fan.

The system can be controlled by an accelerometer. In this embodiment, a control circuit energizes a latching relay if a trend of deceleration is detected over a predetermined duration of time (e.g., about 4 seconds) followed by a trend of no forward motion. The relay routes power to the fan and will maintain its ‘pulled’ state. If a trend of acceleration is detected over a predetermined duration of time, the relay stops power to the fan; the relay will then maintain its ‘released’ state. The durations and trend parameters may be adjustable.

Other methods to detect movement and control power to the fan include GPS, photocell, wheel speed, camera, and motion switches. Each method involves associated logic to interpret data as indicating a stopped condition which would route power to the fan, or an in-motion condition which would stop power to the fan.

In all automatic cases, two switches are provided with the fan unit and installed on the handlebar mount. One switch is provided to enable or disable the automatic mode; when the automatic mode is disabled, the second switch then operates as a simple toggle to turn the fan on or off. Controlling electronics may be installed at some convenient location on the motorcycle (e.g., beneath the motorcycle seat) or integrated into the fan's handlebar mount. In a preferred embodiment, the control logic turns the fan on when the relative airflow or wind speed is between 0 and a predetermined level (e.g., 0 to 10 m/s) and off at relative airflow or a wind speed greater than a predetermined level (e.g., 10 m/s). In a preferred embodiment, the control unit includes a time delay so the fan does not oscillate on and off at threshold values. An example of this is shown in FIG. 8. The 45 seconds in FIG. 8 refers to a point in time within the 200-second timeline. 45 seconds after the timeline begins, the fan comes on because the sensor detects an airflow of less than 10 m/s. Then, in response to the airflow shown with the solid line, the fan remains on during a brief, 3-second gust (from T=54 to T=57). During this gust of airflow greater than 10 m/s (i.e., conditions that have crossed the threshold), because the increase is only momentary, it is preferable that the fan does not turn off even though airflow has increased. So, to prevent this from happening, a delay is programmed into the controller: the program examines sensor values and examines the fan state (on or off) and does not allow a change within a short time span of about three seconds. Thus, if the fan is on, the next signal that would change the state to off must be an off signal that arrives after the delay. In other words, during a fan-on state, a gust exceeding 10 m/s is detected and starts a timer function within the program and after 3 seconds if the gust is still present, then the fan-off condition will be invoked (a brief gust will not turn the fan off, but a longer gust will). If the fan does go into the off state because of a sustained windy condition, the delay works the other way: a very brief lull in the wind won't be enough to turn the fan on, wind speed would need to die down for a longer predetermined period of time in order for the fan to start.

Although an airflow sensor is the best indicator of air movement around the rider's face (and therefore the best basis for control of a rider fan), other methods are possible, including, but not limited to, computing speed from GPS units, cameras (and camera vision software) that calculate speed from video imagery, various types of engine speed and wheel speed sensors, accelerometers, and airflow switches.

Other than airflow sensors (which have no moving parts), the methods of fan control listed herein rely on the correlation of motorcycle speed to air movement around the rider's face. That is, the assumption is that if the motorcycle is moving very slowly or is stopped, the rider feels little or no air movement at his or her face. Of course, air at the rider's face is not always related to motorcycle speed, and riding against or with the direction of the wind, or being stopped in a high wind condition are examples of this unreliable relationship. In addition, if the control method is based on an accelerometer, gravity vectors are critical and, therefore, uphill and downhill braking and accelerating must be accounted for.

Setting thresholds for fan-on and fan-off conditions can be complicated for methods other than airflow sensors. However, an approach with an airflow switch is described below. An airflow switch has a mechanical component such as a small vane or paddle that reacts to the flow of air against it. To control a rider fan, the switch is wired to be ‘normally closed’ and would be positioned on the motorcycle such that when the motorcycle is stopped, the lack of air movement over the switch causes the switch contacts to remain closed, and this state would close a relay to route power to the fan. On the other hand, when the motorcycle is in motion, the resulting air movement against the switch paddle causes the switch contacts to open, which opens a relay and stops power to the fan.

The basic challenge with controlling a rider fan with an airflow switch is that while acceleration of the motorcycle produces a consistent airflow against the switch, deceleration produces an inconsistent airflow. This contrast is due to several effects. Three of these effects are as follows:

Acceleration forces are typically greater than deceleration, meaning that during deceleration the airflow switch is more susceptible to spurious air movements (e.g., the mass of air ‘thrown off’ by nearby vehicles) than during acceleration.

The air pressure wave ahead of the motorcycle and the rider as both entities move forward probably interacts with air impinging on the airflow switch.

The gravity or momentum effect on the switch's paddle is in the opposite direction of the airflow during motorcycle deceleration. That is, airflow, expected to decrease and tending to set the airflow switch into its “switch contacts closed/fan on” state, is actually supplemented by the physical movement of the paddle which, because the motorcycle is slowing, tends to swing toward the “switch contacts closed/fan on” position.

The result of these effects is that a control method relying solely on an airflow switch and latching relay will rapidly oscillate between fan-on and fan-off states during motorcycle deceleration.

To overcome these effects, a possible on-off setting for airflow switch control is the following, assuming a programmable controller is linked to the airflow switch:

Adjust the switch to open relay contacts (fan-off state) at a predetermined speed (e.g., 5 m/s). This insures the fan goes off and stays off with virtually any forward motion.

Program the controller to close relay contacts after a predetermined amount of time (e.g., 3 seconds) of airflow continuously less than 5 m/s. This condition prevents most oscillation because the fan cannot start until 3 seconds have passed with continuous, low airflow against the switch. It will be appreciated by those of ordinary skill in the art that airflow switches can only produce the settings above if a programmable controller is included in the system.

### BRIEF DESCRIPTION OF THE DRAWINGS

FIG. 1 is a side elevational view of a motorcycle having a motorcycle cooling system thereon in accordance with a preferred embodiment of the present invention;

FIG. 2 is a perspective view of the fan assembly of the motorcycle cooling system of FIG. 1 connected to the handlebar of a motorcycle;

FIG. 3 is an exploded perspective view of the fan assembly of FIG. 2;

FIG. 4 is a perspective view of a fan shroud with a portion thereof cutaway;

FIG. 5 is a cross-sectional view of the fan shroud; and

FIG. 6 is an elevational view of a portion of the fan assembly with the adjustment member in cross-section;

FIG. 7 is a schematic of a portion of the system;

FIG. 8A is a graph showing an example of airflow velocity at the sensor when the average wind speed is 1 M/S; and

FIG. 8B is a graph showing an example of airflow velocity at the sensor when the average wind speed is 10 M/S with gusts.

Like numerals refer to like parts throughout the several views of the drawings.

### DETAILED DESCRIPTION OF THE PREFERRED EMBODIMENTS

The following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be, but not necessarily are references to the same embodiment; and, such references mean at least one of the embodiments.

Reference in this specification to “one embodiment” or “an embodiment” means that a particular feature, structure, or characteristic described in connection with the embodiment is included in at least one embodiment of the-disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks: The use of highlighting has no influence on the scope and meaning of a term; the scope and meaning of a term is the same, in the same context, whether or not it is highlighted.

It will be appreciated that the same thing can be said in more than one way. Consequently, alternative language and synonyms may be used for any one or more of the terms discussed herein. No special significance is to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various embodiments given in this specification.

Without intent to further limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions, will control.

It will be appreciated that terms such as “front,” “back,” “top,” “bottom,” “side,” “short,” “long,” “up,” “down,” “aft,” “forward,” “inboard,” “outboard” and “below” used herein are merely for ease of description and refer to the orientation of the components as shown in the figures. It should be understood that any orientation of the components described herein is within the scope of the present invention.

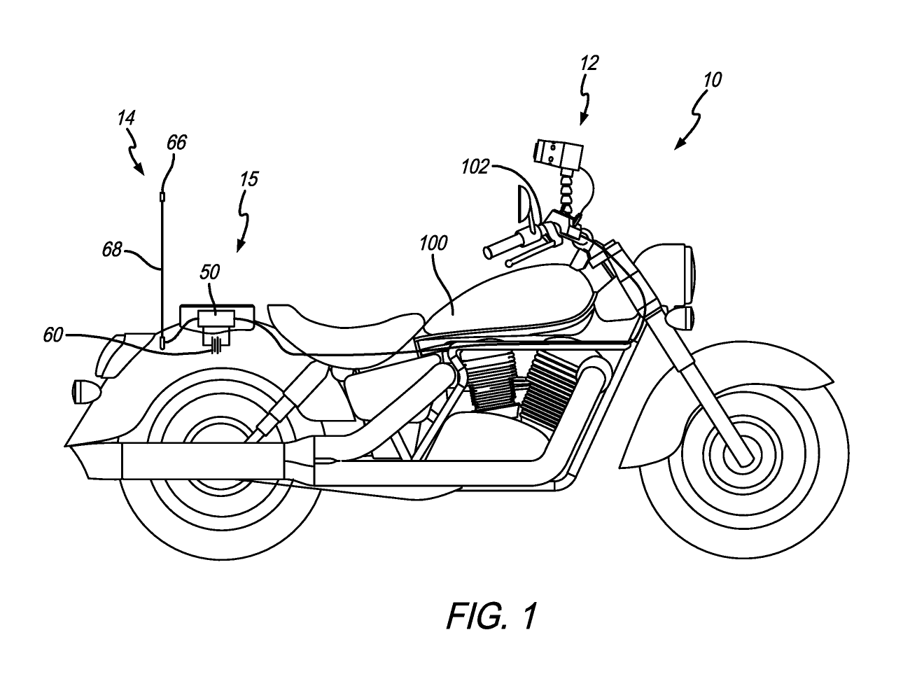

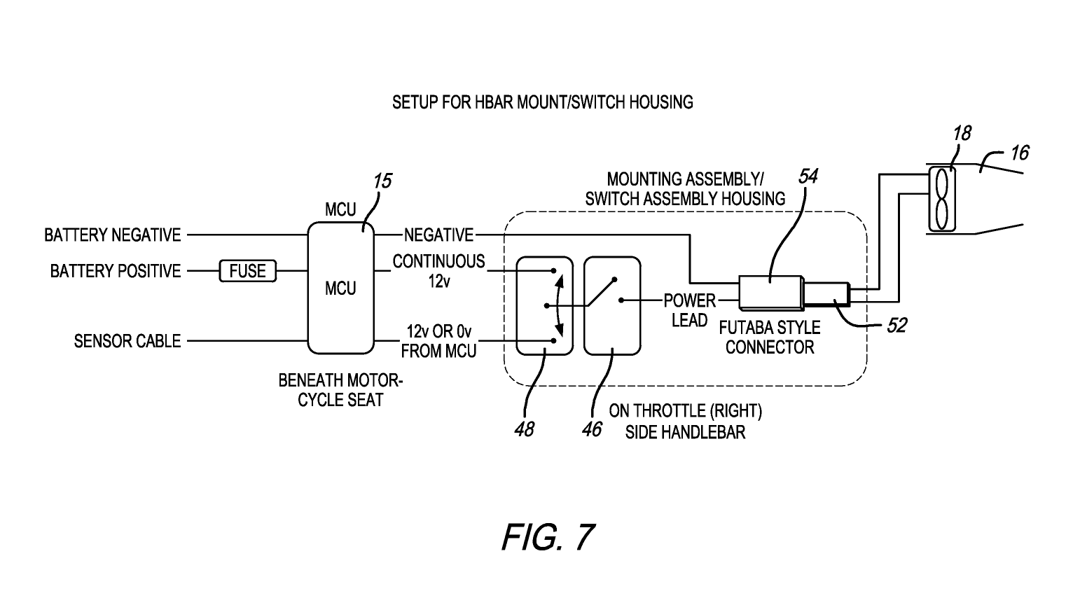

FIGS. 1-7 show a cooling system 10. In the description herein the cooling system 10 is used to cool a motorcycle rider. However, this is only exemplary and not a limitation on the present invention. As shown in FIG. 1, in a preferred embodiment, the cooling system 10 generally includes a fan assembly 12, a sensing member 14 and a controller assembly 15 that are each positioned on a motorcycle 100. In a preferred embodiment, the fan assembly 12 is secured to the handlebar 102 of the motorcycle 100. However, this is not a limitation and the fan assembly 12 can be positioned at any position where it can blow air onto the rider.

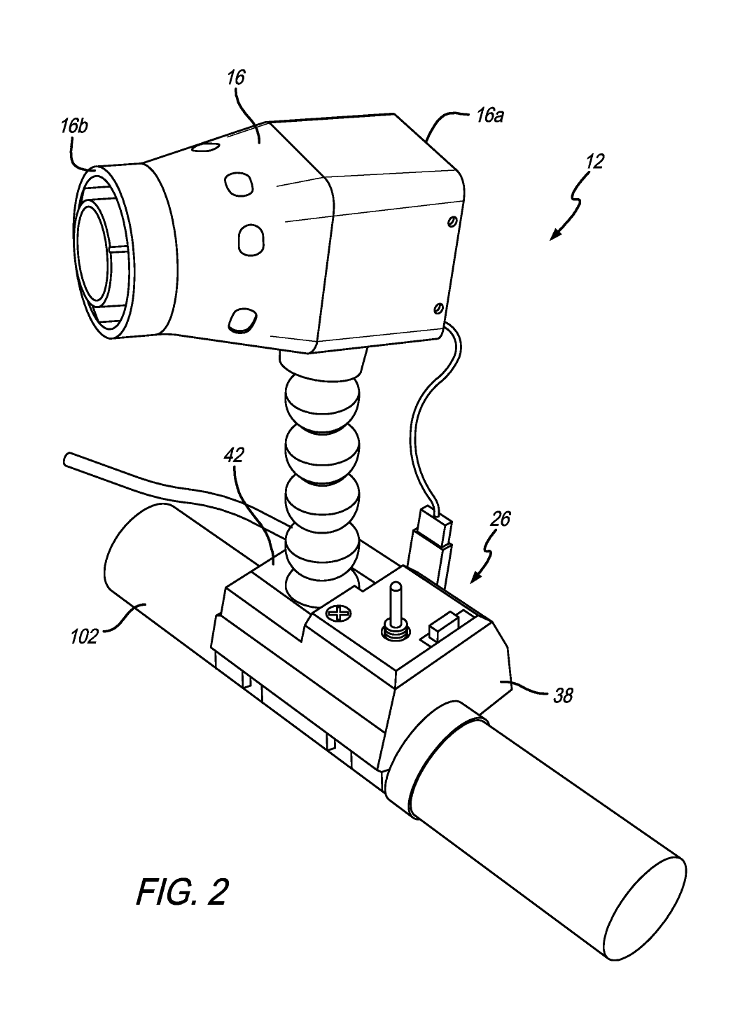

As shown in FIGS. 2-6, the fan assembly 12 generally includes a shroud 16, a fan 18, a finger guard 20, an adjustment member 22, a mounting assembly 24 and a switch assembly 26. The shroud 16 includes a first end 16a where the fan 18 is positioned and a second end 16b through which the air is expelled toward the rider. The fan 18 can be any fan that pushes air and can be positioned in the shroud 16 or can be attached to the back of the shroud 16. The finger guard 20 is secured to the back of the fan 18 or the shroud 16. This can be done with threaded fasteners, glue, welding, a snap fit arrangement, fasteners, etc.

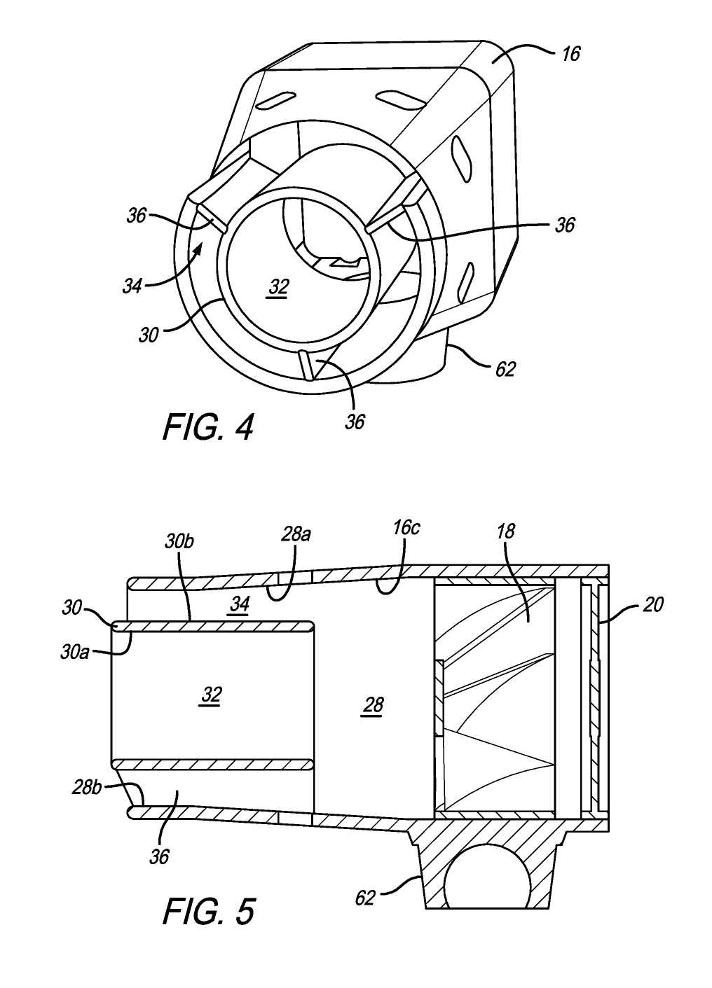

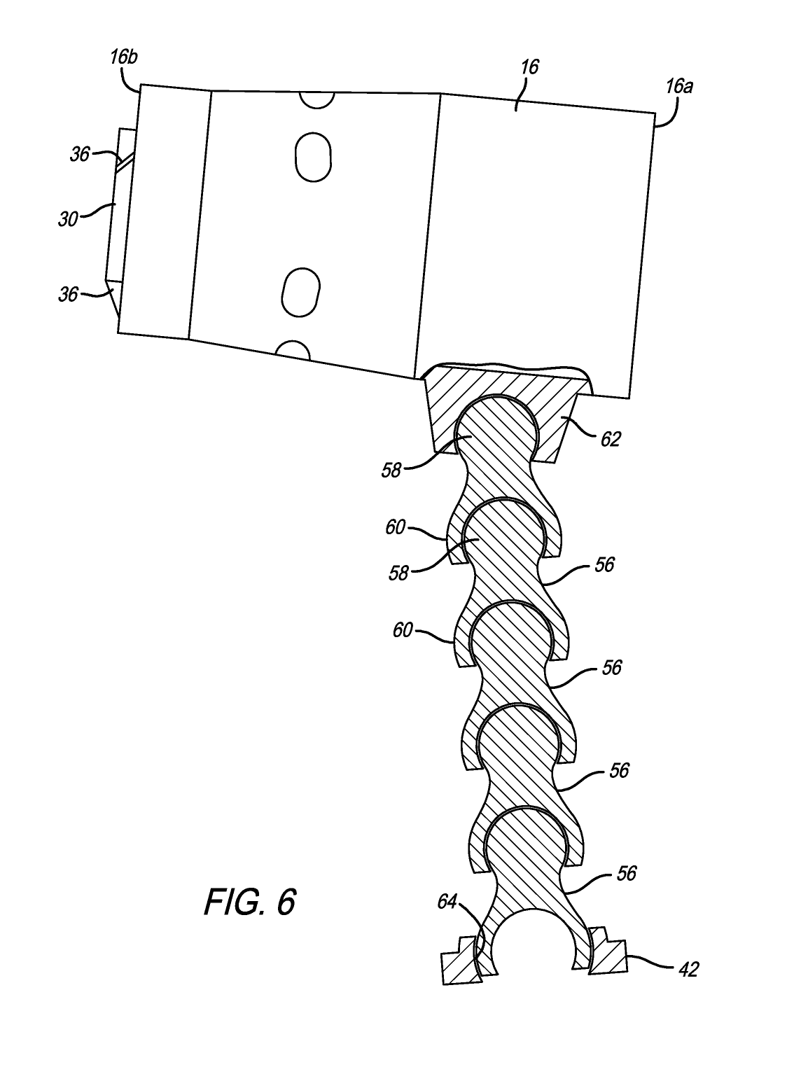

In a preferred embodiment, the fan assembly 12 creates an airflow that is generally laminar. As shown in FIGS. 4 and 5, the shroud 16 has an inner surface 16c that defines a central opening 28 extending therethrough. The fan 18 is in airflow communication with the central opening 28 and is configured to move air through the central opening 16 from the first end 16a to the second end 16b of the shroud 16. In a preferred embodiment, the central opening 28 includes a duct member 30 positioned therein that includes an inner surface 30a and an outer surface 30b. An inner duct pathway 32 is defined by the inner surface 30a and an outer duct pathway 34 is defined between the outer surface 30b of the duct member 30 and the inner surface 16c of the shroud 16, thereby making the shroud an outer duct member.

As shown in FIG. 4, in a preferred embodiment, at least one vane 36 extends inwardly from the inner surface 16c of the shroud 16 to position the duct member 30 coaxially within the central opening 28. Three vanes 36 positioned 120° apart are shown in the drawings. However, any number of vanes from 1 to 10+ is within the scope of the present invention. Preferably, the vanes 36 are flat. In another embodiment, the vanes can be angled, curved or spiraled with respect to the direction of the air to aid with the rotation of the air as it exits the shroud 16. In another embodiment, the duct member can be omitted and the vanes can meet at a center point.

In a preferred embodiment, the central opening 28 includes a tapered portion 28a and a non-tapered portion 28b adjacent the second end 16b of the shroud 16. In another embodiment, the entire central opening can taper from the first end to the second end. In another embodiment, the entire central opening can have the same diameter or dimension (if not round).

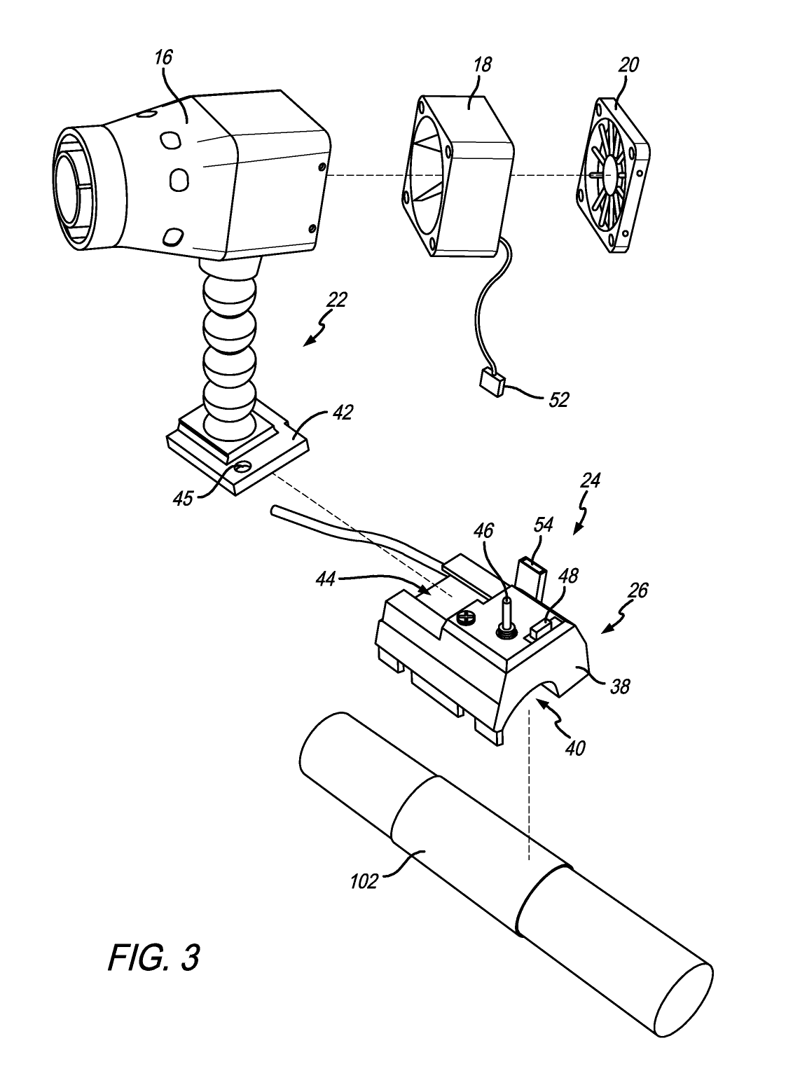

As shown in FIGS. 2-3, in a preferred embodiment, the mounting assembly 24 includes the switch assembly 26 thereon. In another embodiment they can be separate and the switch assembly 26 can be mounted or positioned elsewhere. The mounting assembly 24 preferably includes a main body portion 38 with a handlebar mounting channel 40 defined therein so that the fan assembly 12 can be secured to a handlebar 102. In a preferred embodiment, the fan assembly 12 includes a base plate 42 that is received in a mounting channel 44 in the main body portion 38 so that the fan assembly 12 can be removably affixed to the mounting assembly 24. In a preferred embodiment a screw or other threaded fastener can be used to lock or secure the base plate 42 in position. The threaded fastener can be received in an opening 45 defined in the base plate 42. Other quick release methods and arrangements are within the scope of the present invention. It will be appreciated that other items, such as a camera, can be mounted to the mounting assembly 24.

It will be appreciated that the adjustment member 22 allows a rider to adjust the direction and position of the airflow. For example, the fan assembly 12 can be positioned so that the airflow is directly at the rider's face, slightly raised to clear condensation behind one's goggles, or it can be directed downward towards the tank on a conventional motorcycle, which will help disperse the hot air rising up from the engine.

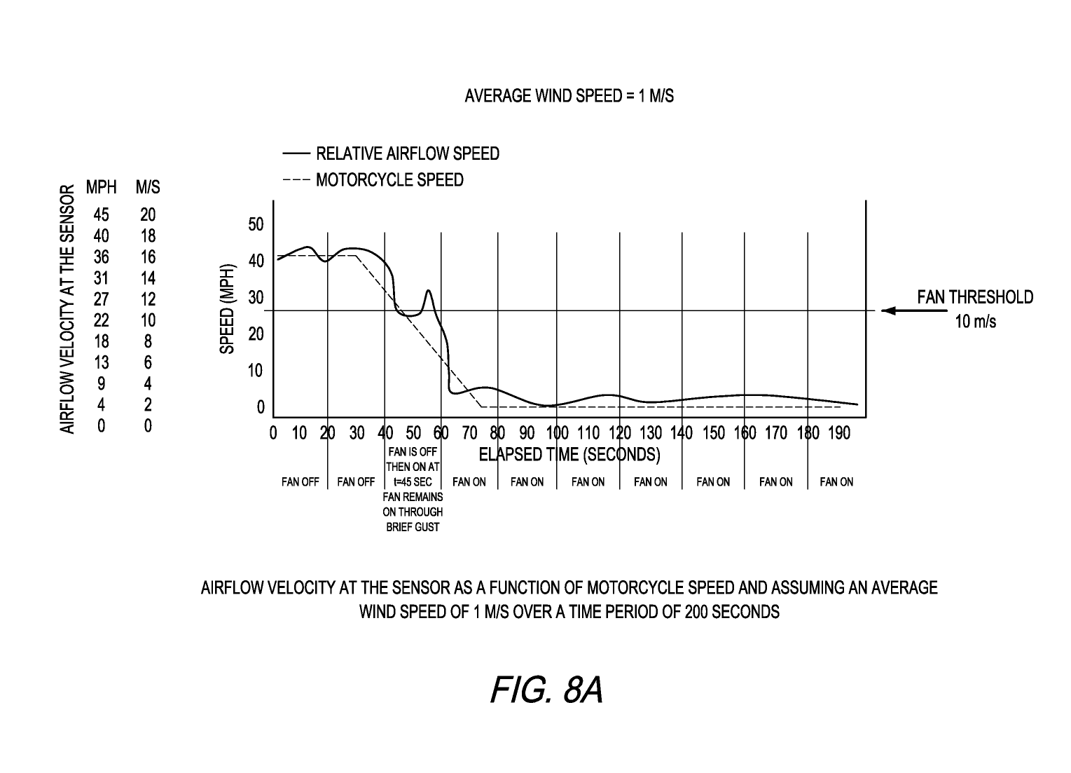

As shown in FIGS. 2-3, in a preferred embodiment, the switch assembly 26 includes a power switch 46 and a mode switch 48. Any type of switch is within the scope of the present invention. The figures show a toggle switch (for power switch 46) and a slider switch (for mode switch 48). However, this is not a limitation and the switches can be push button, rocker or other types of switches known in the art. The power switch 46 turns the entire cooling system 10 on and off. In a preferred embodiment, the mode switch 48 switches the system from manual control mode to automatic control mode, as described below. Therefore, when the mode switch 48 is in the on or automatic position and the power switch 46 is in the on position the fan is controlled and turned on and off based on conditions sensed by the system, as further described below. When the mode switch 48 is in the off or manual position then the power switch 46 turns the fan on and off manually (e.g., when the rider switches the switch between the on and off position). As shown in FIGS. 2-3, in a preferred embodiment, the fan 18 is electrically connected to the mounting assembly 24 and/or switch assembly 26. The drawings show a Futaba-style connection with the male connector 52 extending from the fan 18 and the female connector or socket 54 attached to the mounting assembly 24. However, any electrical connection is within the scope of the present invention. FIG. 7 shows an exemplary electrical schematic of the system 10.

As shown in FIGS. 2-3 and 6, in a preferred embodiment, the adjustment member 22 comprises a plurality of interlocking connection members 56 that provide twisting or rotating movement as well as angled movement with respect to one another. Each connection member 56 includes a generally spherical male portion 58 and a generally spherical female portion 60. The male portion 58 of a connection member 56 is received in the female portion 60 of an adjacent connection member 56. The male portion 58 uppermost connection member 56 is received in the neck portion 62 of the shroud 16. The neck portion 62 preferably has the same or a similar shape to the female portions 60 of the connection members 56. The female portion 60 of the lowermost connection member 56 is received in an opening 64 in the base plate 42. The female portion 60 of each connection member 56 has about the same diameter at its widest point as the diameter of the male portion 60 at its widest point. This arrangement allows movement between each of the adjacent connection members 56 and between the uppermost connection member 56 and the neck portion 62 the shroud and the lowermost connection member 56 and the base plate 42. In another embodiment, the female portion 60 (socket) has a slightly smaller diameter than the male portion 60 (ball) and thus the fit between parts is an interference fit. In a preferred embodiment, when the two parts are pressed together to form a joint the ball and socket are so tightly seated against each other that the joint will resist movement caused by vibration, even though the angle of the joint can be changed with sufficient hand pressure.

It will be appreciated that, when in the automatic mode (when the mode switch 48 is in the on or automatic position), the system 10 is controlled by the controller assembly 15, which includes a controller 50 or master control unit (MCU—see FIG. 7) therein that is in communication with the sensing member 14 and the fan 18. The sensing member 14 can be any sensor, switch, receiver or the like that can sense an environmental condition. For example, the sensing member 14 can be an airflow sensor, an airflow switch, an accelerometer, a global positioning system receiver, a photocell, a wheel or engine speed sensor, a camera, a motion switch or the like. In an exemplary embodiment, the controller assembly 15 is positioned below the motorcycle seat. It will be appreciated that the controller assembly 15 can be associated with or positioned with the switch assembly 26. In other words, both assemblies can be combined into one. For example, they can all be incorporated within the mounting assembly 24 shown in FIGS. 2 and 3.

FIG. 1 shows the sensing member 14 as an airflow sensor 66 that is positioned on a mast 68. An exemplary airflow sensor is the Flow Sensor FS2 available from Innovative Sensor Technology. The sensing member 14 can be positioned anywhere on the vehicle. In an exemplary embodiment, a sensing member 14 with an airflow sensor 66 or other condition sensor (e.g., temperature) is located on the motorcycle such that it can sense changes in air movement or other conditions. The sensor 66 senses or examines trends in air movement. When a trend of no or very small air movement is detected (e.g., when the motorcycle is below a predetermined speed or comes to a stop) a latching relay (located in the controller) closes and power is routed to the fan (the fan 18 turns on). When a trend of substantial air movement is detected (e.g., when the motorcycle is above a predetermined speed), the latching relay opens and stops power to the fan 18.

In a preferred embodiment, the system can be set to turn on and off based on the airspeed or airflow velocity at the sensor (referred to herein as the “relative airflow speed”) as opposed to just being based on vehicle speed. This is because, for example, if the motorcycle is moving at 15 m/s in a northerly direction and the wind is also moving at 15 m/s and northerly direction, the relative airflow speed at the sensor will be 0 m/s. In this scenario, if the system is simply set to turn off when the motorcycle speed is above 10 m/s then the fan would be off. However, the rider would be experiencing a relative airflow speed of approximately 0 m/s, and likely want the fan to be on.

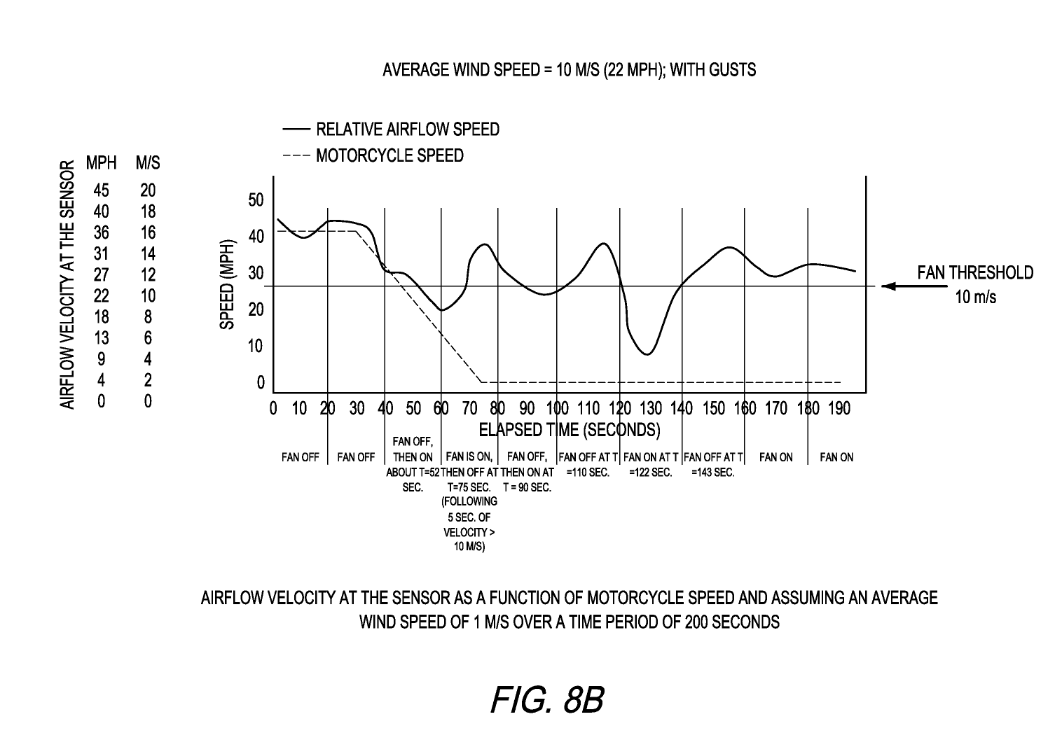

FIGS. 8A and 8B show two examples where the fan is set to turn on (see the fan threshold line) when the relative airflow speed at the sensor is below about 10 m/s. FIG. 8A shows a situation where the average wind speed is 1 m/s and FIG. 8B shows a situation where the average wind speed is 10 m/s and the wind is gusting. In a preferred embodiment, the control unit includes a time delay so that brief changes in airflow do not produce oscillation between on and off states at threshold values. The delay is a programmed function that is initiated when the airflow sensor detects airflow suddenly exceeding or falling below the threshold value. The function examines sensor outputs and examines the state of the fan (on or off) and will not allow a change in the fan state within a short time span of about three seconds. Thus, if the fan is on, the next signal that would change the state to off must be an off signal that arrives after the delay.

It will be appreciated that any range of relative airflow speed is within the scope of the present invention. In preferred embodiment, the fan is set to turn on when the relative airflow speed is between 0 m/s and 30 m/s and off when the relative airflow speed is above 30 m/s. In the most preferred embodiment, the fan is set to turn on when the relative airflow speed is between 0 m/s and 10 m/s and off when the relative airflow speed is above 10 m/s. In another preferred embodiment, the fan is set to turn on when the relative airflow speed is between 0 m/s and 5 m/s and off when the relative airflow speed is above 5 m/s.

In another embodiment, the sensing member 14 can include an airflow switch that is located somewhere on the motorcycle where it is subject to airflow. In this embodiment, a normally closed airflow switch is positioned on the motorcycle such that when the motorcycle is below a predetermined speed or stopped, the lack of air movement over the switch causes the switch contacts to close, which closes a relay to route power to the fan 18. When the motorcycle is above a predetermined speed, the resulting air movement over the switch assembly causes the switch contacts to open, which opens a relay and the controller stops power to the fan 18.

As shown in the drawings, in a preferred embodiment, the control assembly 15, fan assembly 12 and sensing member 14 are in communication via wiring. The wiring can transmit electricity to power the components (see battery 60) and/or control signals or data. In another embodiment, the control signals and/or data can be transmitted wirelessly. For example, the control assembly 15, fan assembly 12 and sensing member 14 can all include at least one of a receiver for receiving the control signals and a transmitter for transmitting the control signals.

In a preferred embodiment, the sensing member 14 is positioned away from the fan assembly 12, for example, at the back of the motorcycle, as shown in FIG. 1. The reason for this is that the fan assembly 12 will often be positioned behind the windshield or fairing. The sensing member 14 should be positioned where it will receive airflow when an airflow sensor is used.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling of connection between the elements can be physical, logical, or a combination thereof. Additionally, the words “herein,” “above,” “below,” and words of similar import, when used in this application, shall refer to this application as a whole and not to any particular portions of this application. Where the context permits, words in the above Detailed Description of the Preferred Embodiments using the singular or plural number may also include the plural or singular number respectively. The word “or” in reference to a list of two or more items, covers all of the following interpretations of the word: any of the items in the list, all of the items in the list, and any combination of the items in the list.

The above-detailed description of embodiments of the disclosure is not intended to be exhaustive or to limit the teachings to the precise form disclosed above. While specific embodiments of and examples for the disclosure are described above for illustrative purposes, various equivalent modifications are possible within the scope of the disclosure, as those skilled in the relevant art will recognize. Further, any specific numbers noted herein are only examples: alternative implementations may employ differing values, measurements or ranges.

The teachings of the disclosure provided herein can be applied to other systems, not necessarily the system described above. The elements and acts of the various embodiments described above can be combined to provide further embodiments. Any measurements described or used herein are merely exemplary and not a limitation on the present invention. Other measurements can be used. Further, any specific materials noted herein are only examples: alternative implementations may employ differing materials.

Any patents and applications and other references noted above, including any that may be listed in accompanying filing papers, are incorporated herein by reference in their entirety. Aspects of the disclosure can be modified, if necessary, to employ the systems, functions, and concepts of the various references described above to provide yet further embodiments of the disclosure.

These and other changes can be made to the disclosure in light of the above Detailed Description of the Preferred Embodiments. While the above description describes certain embodiments of the disclosure, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features or aspects of the disclosure with which that terminology is associated. In general, the terms used in the following claims should not be construed to limit the disclosures to the specific embodiments disclosed in the specification unless the above Detailed Description of the Preferred Embodiments section explicitly defines such terms. Accordingly, the actual scope of the disclosure encompasses not only the disclosed embodiments, but also all equivalent ways of practicing or implementing the disclosure under the claims.

Accordingly, although exemplary embodiments of the invention have been shown and described, it is to be understood that all the terms used herein are descriptive rather than limiting, and that many changes, modifications, and substitutions may be made by one having ordinary skill in the art without departing from the spirit and scope of the invention.

What is claimed is:

1. A motorcycle cooling system comprising:
a controller,
a sensing member for sensing at least one environmental condition, wherein the sensing member is in communication with the controller, and
a fan assembly that includes
a shroud having an inner surface that defines a central opening extending therethrough, and
a fan in airflow communication with the central opening, wherein the fan is configured to move air through the central opening from a first end to a second end of the shroud, wherein the fan is in communication with the controller,
wherein the controller turns the fan on when a first environmental condition is sensed by the sensing member, and wherein the controller turns the fan off when a second environmental condition is sensed by the sensing member.

2. The motorcycle cooling system of claim 1 wherein the sensing member is at least one of an airflow sensor, an airflow switch, an accelerometer, a global positioning system receiver, a photocell, a wheel speed sensor, a camera, and a motion switch.

3. The motorcycle cooling system of claim 1 wherein the environmental condition is at least one of wind speed, temperature or vehicle speed.

4. The motorcycle cooling system of claim 1 further comprising a switch assembly that includes a mode switch that is movable between a manual position and an automatic position, wherein when the mode switch is in the manual position the controller does not control the fan.

5. The motorcycle cooling system of claim 4 wherein the switch assembly further includes a power switch for turning the system on and off.

6. The motorcycle cooling system of claim 1 wherein the central opening includes a duct member positioned therein, wherein the duct member includes an inner surface and an outer surface, wherein an inner duct pathway is defined by the inner surface, and wherein an outer duct pathway is defined between the outer surface of the duct member and the inner surface of the shroud.

7. The motorcycle cooling system of claim 6 wherein at least one vane extends inwardly from the inner surface of the shroud to position the duct member coaxially within the central opening.

8. The motorcycle cooling system of claim 7 wherein the duct member has a first end and a second end, and wherein the length of the duct member from the first end to the second end is shorter than the length from the first end to the second end of the shroud.

9. The motorcycle cooling system of claim 1 wherein the central opening includes a tapered portion.

10. The motorcycle cooling system of claim 9 wherein the central opening includes a non-tapered portion adjacent the second end of the shroud.

11. The motorcycle cooling system of claim 1 wherein the fan assembly includes an adjustment member comprised of at least first and second connection members that each include a generally spherical male portion and a generally spherical female portion, wherein the male portion of the first connection member is received in the female portion of the second connection member.

12. The motorcycle cooling system of claim 11 wherein the male portion of the second connection member is adjustably received in a neck portion of the shroud.

13. The motorcycle cooling system of claim 1 wherein the fan assembly is mounted on a handlebar of a motorcycle, and wherein the sensing member is mounted on the motorcycle at a position remote from the fan assembly.

14. The motorcycle cooling system of claim 4 wherein when the mode switch is in the automatic position the controller controls the fan.

15. The motorcycle cooling system of claim 14 wherein the sensing member senses relative airflow speed, and wherein the fan is turned on when the relative airflow speed is above a predetermined threshold.
